(19) United States
(12) Patent Application Publication
(10) Pub. No.: US 2022/0383394 A1
(43) Pub. Date: Dec. 1, 2022

(54) LIVE SHOPPING BROADCAST

(71) Applicant: Verishop Inc., Santa Monica, CA (US)

(72) Inventors: Jessica Marie Anerella, Brooklyn, NY (US); Imran Khan, Dallas, TX (US); Rong Yan, Santa Monica, CA (US); ChingYao Yu, San Francisco, CA (US); Liu Liu, San Francisco, CA (US)

(21) Appl. No.: 17/532,701

(22) Filed: Nov. 22, 2021

Related U.S. Application Data
(60) Provisional application No. 63/194,797, filed on May 28, 2021.

(51) Int. Cl. G06Q 30/06; G06F 3/14; H04N 21/2187; H04N 21/231; H04N 21/478; G06Q 30/02

(52) U.S. Cl. CPC G06Q 30/0641; G06F 3/1454; H04N 21/2187; H04N 21/231; H04N 21/47815; G06Q 30/0222

(57) ABSTRACT

System and methods for broadcasting and recording live shopping broadcasts. A broadcast stream from a presenter (e.g., influencer) is received and distributed to viewers (e.g., shoppers). Additionally, a start identifier for a product is received from the presenter during the broadcast stream, product details for the product are distributed to the viewers upon receipt of the start identifier for the product, and an end identifier for the product is received from the presenter during the broadcast stream. The broadcast stream is recorded, and portions of the broadcast stream are associated with the product corresponding to a time period between the start identifier and the end identifier to generate a product broadcast file (e.g., for display and presentation) along with the product in an online marketplace.

### TECHNICAL FIELD

Examples set forth in this disclosure relate generally to applications running on client devices and server systems supporting those devices. More particularly, but not by way of limitation, this disclosure addresses live shopping systems and methods for use with an online marketplace.

### BACKGROUND

Online marketplaces enable remotely located individual users to purchase items using an electronic device such as a home computer or a mobile device. In conventional systems, the users access the online marketplaces through web browsers or applications (apps) running on their electronic devices. The users are able to navigate screens presented by the online marketplaces for viewing via their browsers or apps. The screens include items available for purchase from the online marketplace. The users may select and purchase these items through the online marketplace.

Live shopping (also known as live stream shopping) includes a live streaming broadcast in which a presenter (e.g., an influencer) promotes a product. While the influencer promotes the product, people can watch these live streams and buy products from an online marketplace. In this way, the activity of shopping is translated from offline into the digital world.

### BRIEF DESCRIPTION OF THE DRAWINGS

The disclosed subject matter is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. To easily identify the discussion of any particular element or act, the most significant digit or digits in a reference number refer to the figure number in which that element is first introduced. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram of an example live shopping system.

FIG. 2 is a block diagram illustrating an example backend server system of the live shopping system of FIG. 1.

FIG. 3 is a block diagram illustrating an example client-side system of the live shopping system of FIG. 1.

FIG. 4A is a flow chart of example steps for setting up a live shopping broadcast.

FIG. 4B is a flow chart of example steps for distributing and recording a live shopping broadcast.

FIG. 4C is a flow chart of example steps for assembling and serving a presenter page including portions of a live shopping broadcast corresponding to products.

FIG. 4D is a flow chart of example steps for assembling and serving a product purchase page including portions of a live shopping broadcast corresponding to products.

FIG. 4E is a flow chart of example steps for tracking purchases corresponding to products presented by a presenter in a live shopping broadcast.

FIG. 5A is an example live shopping broadcast presenter graphical user interface (GUI) for presentation on a display of a client-side electronic device.

FIG. 5B is an example presenter product detail page GUI for presentation on a display of a client-side electronic device.

FIG. 6 is an example live shopping broadcast viewer GUI for presentation on a display of a client-side electronic device.

FIG. 7A is an example live shopping broadcast product detail page GUI for presentation on a display of a client-side electronic device.

FIG. 7B is an example live broadcast focus presenter GUI for presentation on a display of a client-side electronic device.

FIG. 7C is an example product focus presenter GUI for presentation on a display of a client-side electronic device.

FIG. 7D is an example collection view GUI for presentation on a display of a client-side electronic device.

FIG. 8 is a diagrammatic representation of an example hardware configuration for a client device embodied as a mobile device.

FIG. 9 is a diagrammatic representation of a machine in the form of a computer system within which a set of instructions may be executed for causing the machine to perform any one or more of the methodologies described herein, in accordance with some examples.

FIG. 10 is block diagram showing a software architecture within which aspects of the present disclosure may be implemented, in accordance with some examples.

### DETAILED DESCRIPTION

Examples of system and methods for broadcasting and recording live shopping broadcasts are described herein. In one example, a broadcast stream from a presenter (e.g., influencer) is received and distributed to viewers (e.g., shoppers). A start identifier for a product to be presented is received from the presenter during the broadcast stream, product details for the presented product are distributed to the viewers upon receipt of the start identifier for the product, and an end identifier for the product is received from the presenter during the broadcast stream. The broadcast stream is recorded, and portions of the broadcast stream are associated with the product corresponding to a time period between the start identifier and the end identifier to generate a product broadcast file (e.g., for display and presentation) along with the product in an online marketplace.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

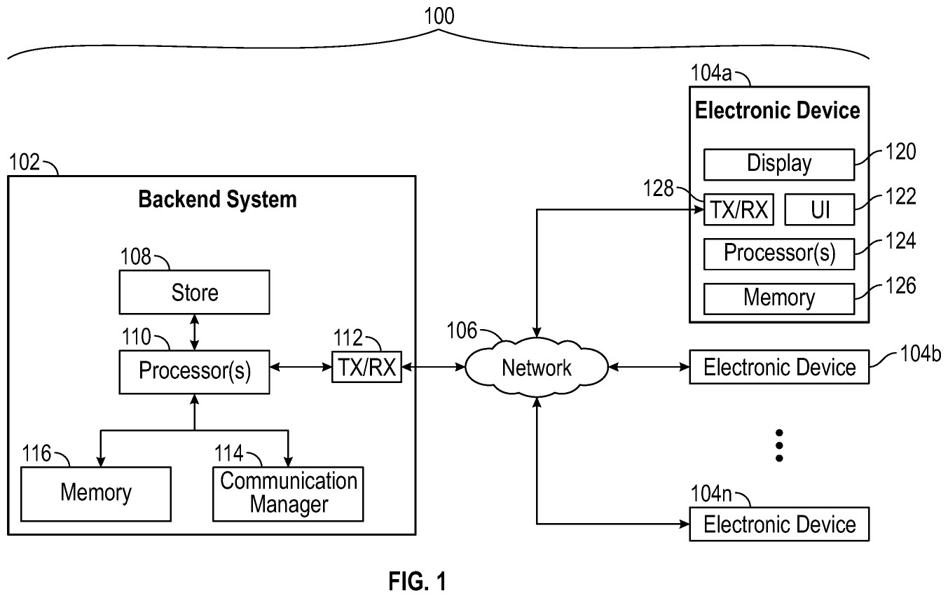

FIG. 1 is a block diagram illustrating a live shopping system 100 according to some examples. The system 100 includes a backend system 102 providing access to items in an online store 108 and two or more client devices such as electronic devices 104a-n for accessing the online store 108. The backend system 102 additionally manages communication flow with the electronic devices 104 and between electronic devices to produce a live shopping experience. Communications between the backend system 102 and the electronic device 104 occur over a network 106 such as the Internet. In one example, the communications take place through a full-service network gateway.

The illustrated backend system 102 includes an online store 108, processor(s) 110, a transceiver (TX/RX) 112, a communication manager 114, and a memory 116. The store 108 is an online marketplace including items for purchase. In one example, the online store 108 is a marketplace hosted by the provider of the backend system 102. In another example, the online store 108 is a remote marketplace accessed by the backend system 102 via the network 106.

The TX/RX 112 handles communication between the backend system the electronic devices 104. The TX/RX 112 formats communications from the backend system into an appropriate format for transmission via the network 106 and interpretation by the electronic devices 104. The TX/RX 112 additionally interprets communications from the electronic devices 104 received via the network 106. A suitable TX/RX 112 is a conventional transceiver used in social media web server systems.

The communication manager 114 manages group data received from each of the electronic device 104 for delivery to each of the other electronic devices 104 to implement live shopping. In one example, the communication manager 114 maintains a table (e.g., in memory 116) that includes address information for each of the electronic devices invited to and attending a live shopping broadcast. When data for dissemination to others (e.g., an invite prior to a live shopping broadcast, communications during a live shopping broadcast, a camera capture frame, or a screen capture frame) is received from one of the electronic devices 104 (identified based on a source address), that information is communicated to the electronic devices 104 of others at their associated addresses.

The processor(s) 110 are one or more processors for controlling the components of the backed end system 102. The memory 116 stores instructions for execution by the processor(s) 110 to provide the functionality of the backend system 102. The processor(s) 110 are coupled to the store 108, the TX/RX 112, the communication manager 114, and the memory 116. Suitable processors 110 and memory 116 are conventional processors and memory used in social media web server systems. In one example, the memory 116 may include cloud-based storage.

The backend system 102 additionally includes an application program interface (API) server and a web server (not shown) that may be communicatively coupled with one or more database(s) maintained in memory 116. The one or more database(s) may be storage devices that store data (e.g., in a dataset) related to hosts and viewers of live shopping broadcasts using the live shopping system 100, applications associated with the backend system 102, cloud services, and so forth. The one or more database(s) may further store information related to electronic devices 104, client application(s), users, user groups, and so forth.

The illustrated electronic device 104a includes a display 120, a user interface 122, a processor(s) 124, a memory 126 and a transceiver (TX/RX) 128. The electronic device 104a is configured to access a shopping platform such as a store 108 through the backend system 102 over the network 106. For example, the electronic device 104a may be used to input information to create an account, exchange information with the backend system 102 over the network 106, and so forth. The electronic device 104a is additionally configured for communication (audio/video/textual) with other electronic devices 104b-n. In one example, the other electronic devices 104b-n are the same or similar to the electronic device 104a.

The display 120 is configurable to display information of the electronic device and received from the other electronic device. The display information of the electronic device includes camera frames captured by the electronic device (e.g., to provide the user with visual feedback on their appearance) and browser frames (e.g., to enable the user to view items for sale by the store 108, product detail pages, and shopping carts). The display information received from other electronic devices 104 includes camera frames or screen frames sent by those devices. The received camera frames and screen frames may be presented on the display 120 in full screen or in a picture in picture (PIP) associated with the user from which those frames were received.

The electronic devices 104 include, but are not limited to, mobile phones, desktop computers, laptops, portable digital assistants (PDA), smart phones, tablets, ultrabooks, netbooks, laptops, or any other communication device that a user may utilize to access the backend system 102. The user interface (UI) 122 includes devices such as a touchscreen or a microphone through which the user can make selections and provide feedback.

The processor(s) 124 are one or more processors for controlling the components of the electronic device 104a. The memory 126 stores instructions for execution by the processor(s) 124 to provide the functionality of the electronic device 104a. The processor(s) 110 are coupled to the display 120, the user interface 122, the TX/RX 128, and the memory 126. The processor(s) 124 may include separate audio and video processors for processing audio and video signals generated or received by the electronic device 104a. Suitable processor(s) 124, memory 126, and TX/RX 128 are conventional processors, memory, and transceivers used in mobile electronic device capable of implementing social media applications.

The electronic device 104a may access the various data and applications provided by other entities in the system 100 via a web client (e.g., a browser; not shown) or one or more client applications stored in memory 126 of the electronic device 104a. The electronic device 104a may include one or more client application(s) (also referred to as “apps”) such as, but not limited to, a web browser, messaging application, an e-commerce site application (e.g., application for accessing store 108 of the backend system 102), and the like.

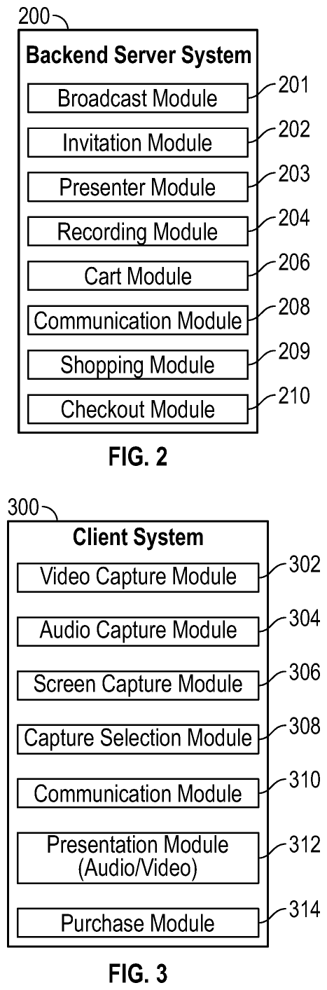

FIG. 2 is a block diagram illustrating modules of an example backend server system 200 of the live shopping system 100. The backend server system 200 includes a broadcast module 201, an invitation module 202, a presenter module 203, a recording module 204, a cart module 206, a communication module 208, a shopping module 209, and a checkout module 210. Each of the modules include instructions (e.g., for execution by processor 110) to configure the backend system 102 to provide the functionality described herein.

The broadcast module 201 configures the backend system 102 to set up and carry out a live shopping broadcast. To set up a live shopping broadcast, the broadcast module 201 receives broadcast details from the presenter (e.g., an influencer) or a representative of the presenter. During the live shopping broadcast, the broadcast module 201 receives a live audio/video stream from the presenter and distributes it to the viewers of the live shopping broadcast (e.g., via communication module 208). Additionally, the broadcast module receives product identifiers for products the presenter discusses during the live shopping broadcast and distributes information to the viewers' devices (e.g., for presentation in tiles and product detail pages).

The invitation module 202 configures the backend system 102 to send out invitations to the live shopping broadcast. The invitation module 202 receives broadcast details including presenter information (name and user ID), guest information (e.g., names and user IDs), and broadcast details (e.g., date, start time, duration, theme, collection(s), etc.). The invitation module 202 stores the information in the memory 116, sends invites to the potential viewers, and tracks RSVPs from the potential viewers.

The presenter module 203 collects information related to the presenter, assembles presenter page information, and serves the presenter page information over the network for viewing on electronic devices 104 via a web browser. In one example, the presenter page information includes information about the presenter, product listings for products the presenter discussed during a live shopping broadcast, and portions of the live shopping broadcast corresponding to each product in the product listing.

The recording module 204 records the live shopping broadcast, associates individual portions of the live shopping broadcast with corresponding products discussed during those portions, and prepares and stores files including the live shopping broadcast portions corresponding to products and identification information for those products. In an example, the recording module 204 receives product identification information and broadcast start/end information from the presenter module 203 that is based on activity of the presenter (e.g., selection of products from a predefined selection of products) during the live shopping broadcast.

The cart module 206 maintains individual shopping carts for each of the viewers. In one example, the cart module 206 maintains information identifying whether items in the shopping cart were accesses via a link provided by the broadcast module during a live shopping broadcast or associated with a portion of the live shopping broadcast (e.g., in order to credit the presenter for sales resulting from their live shopping broadcast or subsequent view of a portion of the live shopping broadcast corresponding to the purchased product).

The communication module 208 distributes broadcast communications (e.g., audio/visual streams and product identifiers) from the presenter to the viewer and manages textual communications among the host and viewers. In one example, communications (e.g., camera frames, video frames, text, and audio) received from the presenter is distributed to all viewers and textual communications received from a viewer during the live shopping broadcast is communicated to the presenter, other viewers, or both.

The shopping module 209 maintains a list of products available for selection and purchase from an online marketplace. In one example, the shopping module is configured to server pages including descriptions of each of the products, a link to a product broadcast file for each product by one or more presenters and purchasing information for the product. The shopping module may interface with the cart module 206 to receive information identifying whether items in the shopping cart being purchased were accesses via a link provided by the broadcast module during a live shopping broadcast or associated with a portion of the live shopping broadcast (e.g., in order to credit the presenter).

The checkout module 210 manages purchases by the viewer. The checkout module 210 presents a user with the contents of their shopping cart and purchase information when requested by the viewer. The checkout module 210 may additionally determine incentives (e.g., discounts and free gifts) and present the incentives to the viewer. Additionally, the checkout module 210 may provide credit to the presenter for completed sales attributable to the presenter (e.g., based on information received via the car module 206 and shopping module 209.

FIG. 3 is a block diagram illustrating modules of a client system 300 of the shopping system 100. The client system 300 includes a video capture module 302, an audio capture module 304, a screen capture module 306, a capture selection module 308, a communication module 310, a presentation module 312, a user activity module 314, and a purchase module 316. Each of the modules include instructions (e.g., for execution by processor 124) to configure the electronic devices 104 to provide the functionality described herein.

The video capture module 302, captures video at the electronic device 104. In one example, the video capture module 302 captures frames of images produced by a camera of the electronic device 104. The video capture module 302 may store the frames of images in the memory 126. In one example, the frames of images are images of the user of the electronic device 104.

The audio capture module 304, captures audio signals at the electronic device 104. In one example, the audio capture module 304 captures audio signals produced by a microphone of the electronic device 104. The audio capture module 304 may store the audio signals in the memory 126. In one example, the audio signals are spoken words of the user of the electronic device 104.

The screen capture module 306, captures images at the electronic device 104. In one example, the screen capture module 306 captures frames of images presented on a display of the electronic device 104. The screen capture module 306 may store the frames of images in the memory 126. In one example, the frames of images are images of browser windows displaying shopping pages.

The capture selection module 308, identifies the captured information to send to the backend system 102 for distribution to the other users. In one example, the capture selection module 308 identifies captured information to send responsive to a user designation. If the user is the presenter, all captures audio and video is communicated to the devices 104 of all viewers. If the user is a viewer, only textual communications are communicated from that viewer to the host and all other viewers.

The communication module 310, sends communications from the electronic device 104 to the backend system 102 for distribution to the presenter and the viewers. Additionally, the communication module sends product identification information from the presenter to the viewers identifying the product the presenter is presenting on.

The presentation module 312, presents communications on the electronic device 104. The presentation module 312 presents video signals on the display of the electronic device 104. In one example, the presentation module 312 of the presenter presents video signals from the camera of the presenter's electronic device in a main display area, a product selection carousel, and text messages. In accordance with this example, the presentation module of a viewer presents video signals from the camera of the presenter's electronic device in a main display area, a product tile (for a particular product after a selection of that product is made by the presenter from the product selection carousel), and text messages.

The purchase module 314 presents incentives to the user and receives payment information to purchase items in the user's shopping cart. In an example, the purchase module 314 communicates with the checkout module 210 using a secure encryption channel to complete purchases.

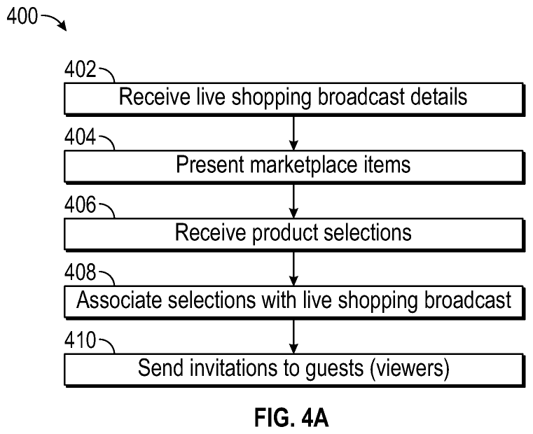

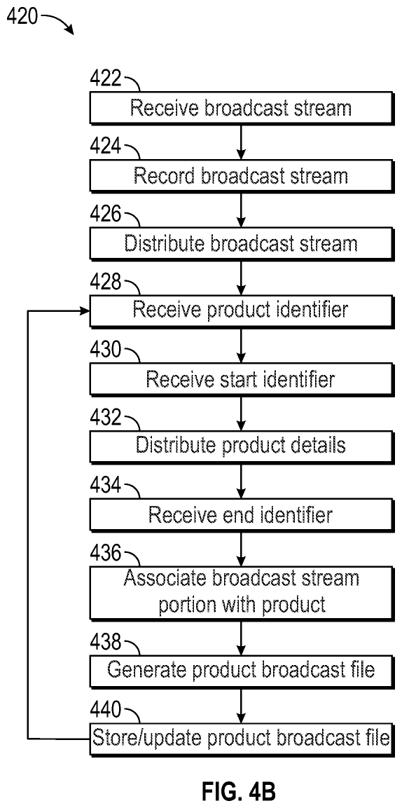

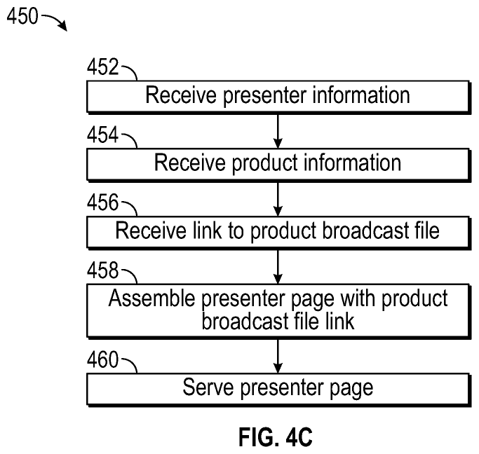

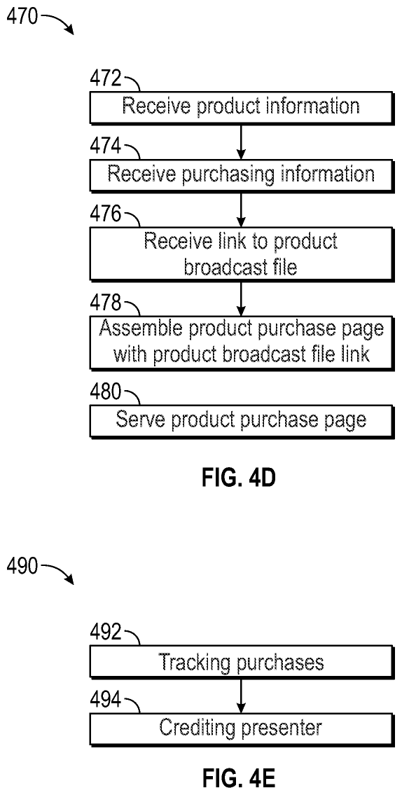

FIG. 4A is a flow chart illustrating an example method 400 for setting up a live shopping broadcast, FIG. 4B is a flow chart illustrating an example method 420 for distributing and recording a live shopping broadcast, FIG. 4C is a flow chart illustrating an example method 450 for assembling and serving a presenter page including portions of a live shopping broadcast corresponding to products, FIG. 4D is a flow chart illustrating an example method 470 for assembling and serving a product purchase page including portions of a live shopping broadcast corresponding to products, and FIG. 4E is a flow chart illustrating an example method 490 for tracking purchases corresponding to products presented by a presenter in a live shopping broadcast. Although the below description of the methods refers to the shopping system 100, other systems for live shopping will be understood from the description herein. The flowcharts may describe the operations as a sequential process, however, many of the operations can be performed in parallel or concurrently. In addition, the order of the operations may be re-arranged. A process is terminated when its operations are completed. A process may correspond to a method, a procedure, etc. The steps of a method may be performed in whole or in part, may be performed in conjunction with some or all of the steps in other methods, and/or may be performed by any number of different systems.

At block 402, the backend system 102 receives broadcast details from a presenter electronic device 104. In an example, the broadcast module 201 of the backend server system 200 serves a page for display on the presenter electronic device 104 including fields for input of broadcast details (e.g., date, time, title, topic, users to receive invites, etc.). In accordance with this example, the presenter fills in the input fields and submits the form for receipt by the backend system.

At block 404, the backend system 102 presents products in an online market to the presenter electronic device 104 for selection. In an example, the broadcast module 201 of the backend server system 200 serves a page for display on the presenter electronic device 104 including products available via the shopping module 209. In accordance with this example, the products displayed are selectable by the presenter via the electronic device 104 (e.g., by tapping on the product).

At block 406, the backend system 102 receives product selections including at least the product. In an example, the broadcast module 201 of the backend server system 200 receives product selections responsive to the presenter selecting products displayed on the presenter electronic device 104 (see block 404 and related description).

At block 408, the backend system 102 associates the product selections with a shopping broadcast. In an example, the broadcast module 201 adds product identifiers corresponding to the selected product to a shopping broadcast file stored in memory 116 that contains details regarding the shopping broadcast.

At block 410, the backend system 102 sends invitations to potential viewers. In an example, broadcast module 201 transfers information regarding users to receive invitations to invitation module 202. The invitation module 202 retrieves addresses for the users from memory 116 and sends an invitation to the users including details regarding the live broadcast and manages responses from the users. In one example, the backend system 102 sends a link (e.g., via the app, SMS messaging, or an email) for joining the live shopping broadcast along with details for the live shopping broadcast.

At block 422, the backend system 102 receives a broadcast stream from a presenter for a live shopping broadcast. In an example, the broadcast module 201 receives video from video capture module 302 and audio from audio capture module 304 of a presenter device 104 over the network 106.

At block 424, the backend system 102 records the broadcast stream (e.g., video and audio). In an example, the recording module 204 records the broadcast stream and stores it in memory 116.

At block 426, the backend system 102 distributes the broadcast stream to viewers. In an example, the broadcast module 204 distributes the broadcast stream (e.g., video and audio) via communication module 208 to viewer device(s) 104 over the network 106.

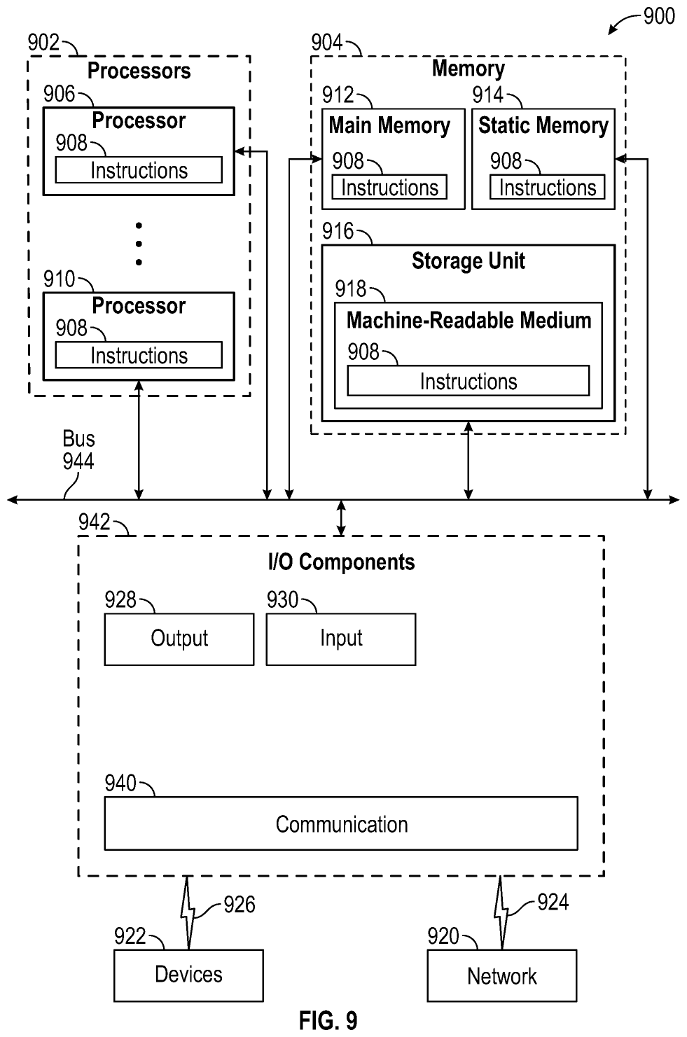

At block 428, the backend system 102 receives a product identifier for a product from the presenter during the broadcast stream. In an example, the broadcast module 204 serves predefined selected products for selection in a carousel (see FIG. 9A) presented on the presenter user device 104 during the live shopping broadcast. Selection of a product from the carousel (e.g., by tapping on a product image) results in a product identifier for the selected product being communicated from the presenter device 104 to the broadcast module 201.

At block 430, the backend system 102 receives a start identifier for a product from the presenter during the broadcast stream. In an example, the receipt of a product identifier functions as a start identifier. The broadcast module records the time of receipt of the product identifier/start identifier for use in defining portions of the live shopping broadcast corresponding to a product.

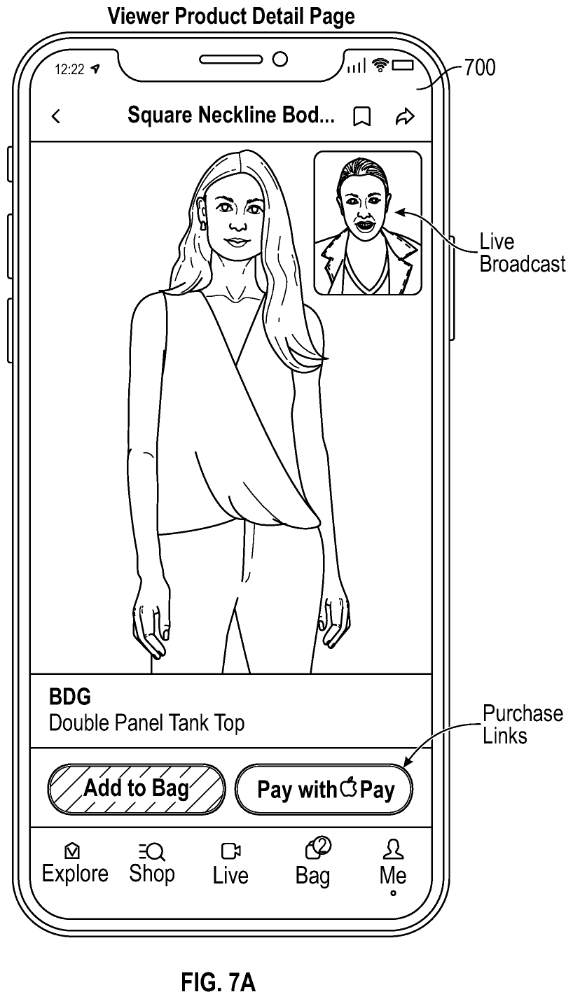

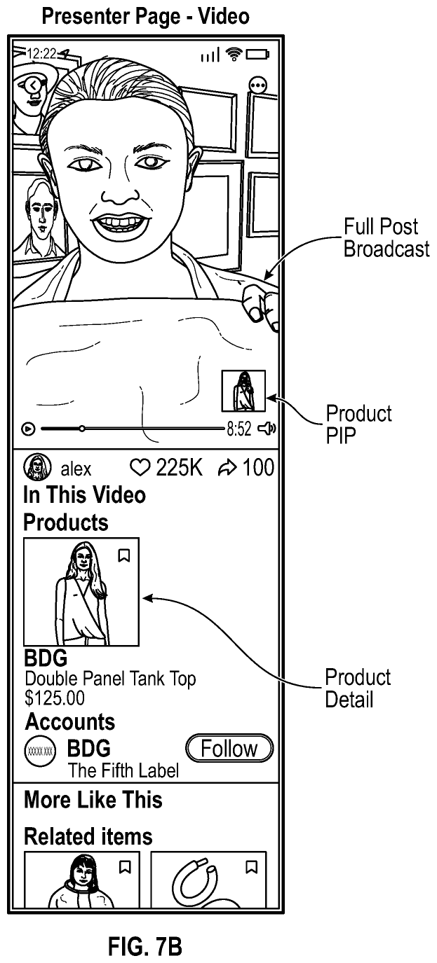

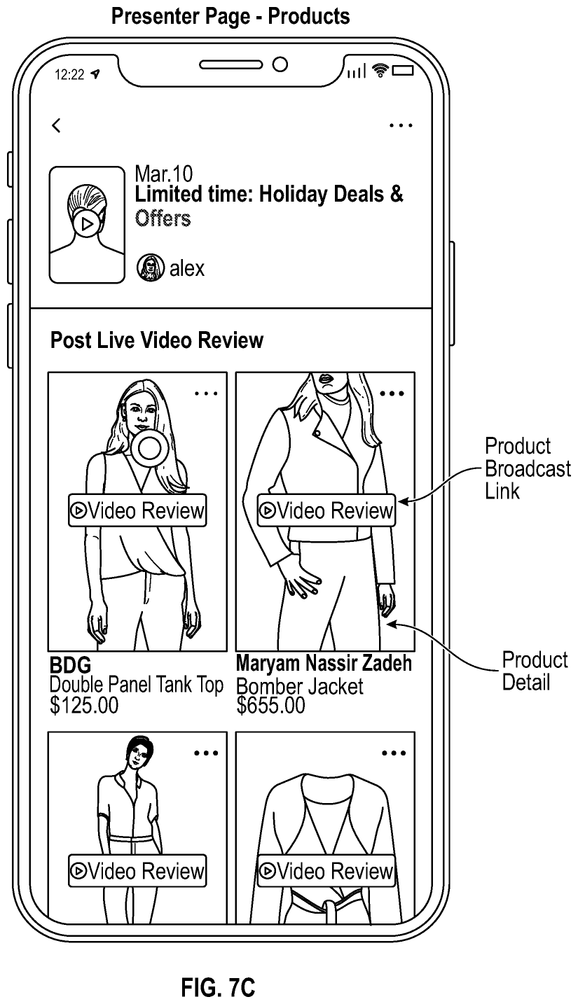

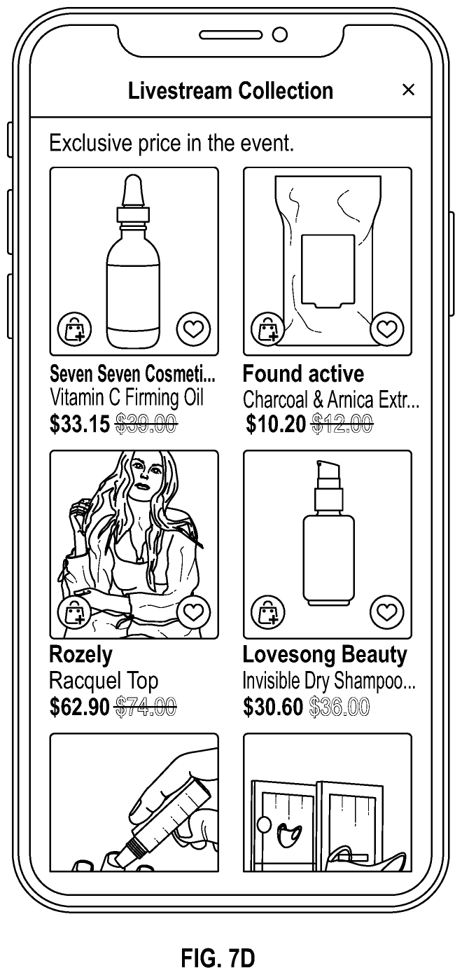

At block 432, the backend system 102 distributes product details for the product to the electronic devices 104 of viewers. In an example, the broadcast module 201 distributes product information for presentation as a selectable tile overlaid on the live shopping broadcast. The product information corresponds to a product associated with the received product identifier (see block 428). Selection of the selectable tile results in the backend system 102 serving a product detail page (see FIG. 7) for display on the client device 104.

At block 434, the backend system 102 receives an end identifier for the product from the presenter during the broadcast stream. In an example, the end identifier is the start identifier for a subsequently selected product. The broadcast module records the time of receipt of the product end identifier for use in defining portions of the live shopping broadcast corresponding to a product.

At block 436, the backend system 102 associates a portion of the broadcast stream with the product corresponding to a time period between the start identifier and the end identifier. In an example, the recording module 204 selects portions of the broadcast stream occurring between the start and end identifiers corresponding to a product.

At block 438, the backend system 102 generates a product broadcast file including the portion of the broadcast stream and a product identifier for the product. In an example, the recording module 204 generates the product broadcast file including the portion of the broadcast stream and the product identifier for the product.

At block 440, the backend system 102 stores or updates a previously stored product broadcast file. In an example, the recording module 204 stores the product broadcast file including the portion of the live shopping broadcast stream and the product identifier for the product. In another example, the recording module 204 updates a previously stored product broadcast file including the previously stored portion of the broadcast stream by adding a subsequent portion of the broadcast for the same product. This example accommodates a presenter presenting on a first product, switching to a second product, and returning to the first product (e.g., through selection of products from the carousel during the live shopping broadcast).

The steps of blocks 428 through 440 are repeated for subsequent selections of preselected products by the presenter.

At block 452, the backend system 102 receives presenter information. In an example, the presenter module 203 receives presenter information from the electronic device 104 of the presenter. Presenter information includes, by way of non-limiting example, name, location, style, images, bibliography, or a combination thereof.

At block 454, the backend system 102 receives product information. In an example, the presenter module 203 receives product information from the electronic device 104 of the presenter. Product information includes product identification information for products available in the store 108. Presenter module 203 may provide the electronic device 104 with access to the store 108 via shopping module 208. The presenter, using mobile device 104 may browse the store 108 and select items for inclusion on their presenter page.

At block 456, the backend system 102 receives a link to a product broadcast file. In an example, presenter module 203 receives links to product broadcast file(s) from the recording module 204.

At block 458, the backend system 102 assembles a presenter page with the product broadcast file link. In an example, presenter module 203 provides the electronic device with a customizable page for organizing the presenter information, product information, and product broadcast file links. In an example, the presenter module 203 automatically associates product broadcast file links with corresponding products including the product information by matching product identification information stored with the product broadcast links to product identification information associated with the products in the product information.

At block 460, the backend system 102 serves the presenter page. In one example, the presenter module 203 produces a presenter page that is associated with a uniform resource locator (URL) and the presenter module 203 serves the presenter page to electronic devices 104 that point a browser to the URL (e.g., via the communication module 208).

At block 472, the backend system 102 receives product information. In an example, the shopping module 209 receives product information from a backend administrator. Product information includes product identification information for products available in the store 108. Shopping module 209 may provide the backend administrator with access to the store 108.

At block 474, the backend system 102 receives purchasing information. In an example, the shopping module 209 receives purchasing information for the products in the store from the backend administrator.

At block 476, the backend system 102 receives a link to a product broadcast file. In an example, the shopping module 209 receives links to product broadcast file(s) from the recording module 204.

At block 478, the backend system 102 assembles a product page with the product broadcast file link. In an example, shopping module 209 produces a template, for each product, that includes the product information, purchase information and broadcast file link(s) for live shopping broadcast portions corresponding to that product. In an example, the shopping module 209 automatically associates product broadcast file links with corresponding products including the product information by matching product identification information stored with the product broadcast links to product identification information associated with the products in the product information.

At block 480, the backend system 102 serves the product purchase page. In one example, the shopping module 209 produces a product purchase page for each product that is associated with a uniform resource locator (URL) and the presenter module 203 serves the product purchase page to electronic devices 104 that point a browser to the URL (e.g., via the communication module 208).

At block 492, the backend system 102 tracks purchases. In an example, the purchase module 314 tracks purchases including information indicative of the incentive to purchase a product. Indicative information includes tracking access to a product via a display tile during a live shopping broadcast, access to the product via a link for a presenter page, or review of a portion of a live shopping broadcast corresponding to the product.

At block 494, the backend system 102 credits presenters (e.g., influencers) for purchases linked to the presenters (e.g., either their presenter page, their live shopping broadcasts, or their portions of live broadcasts for specific products).

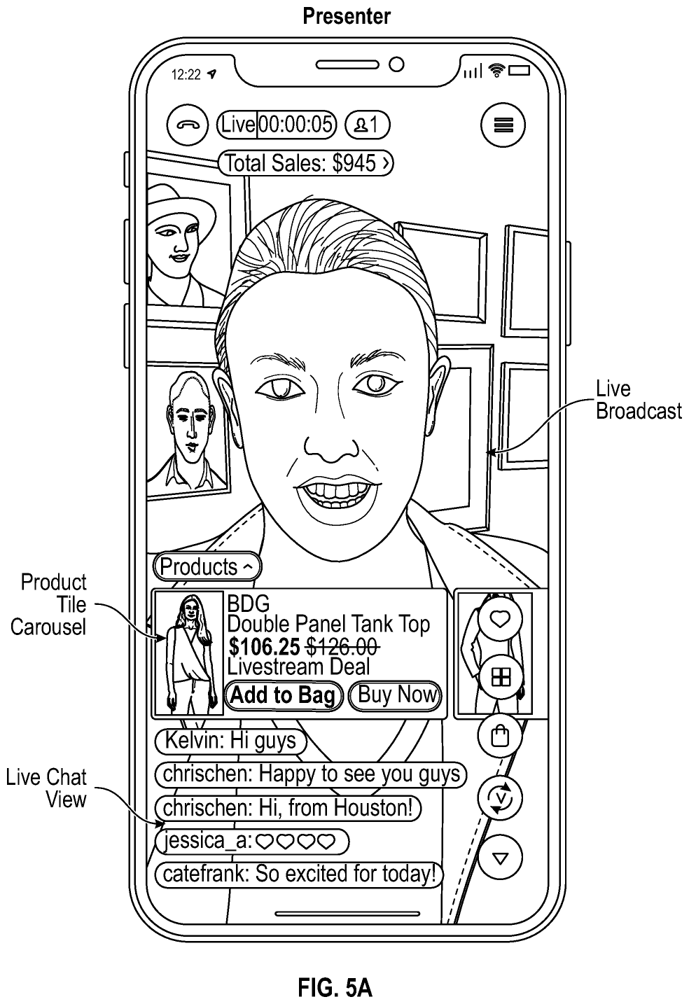

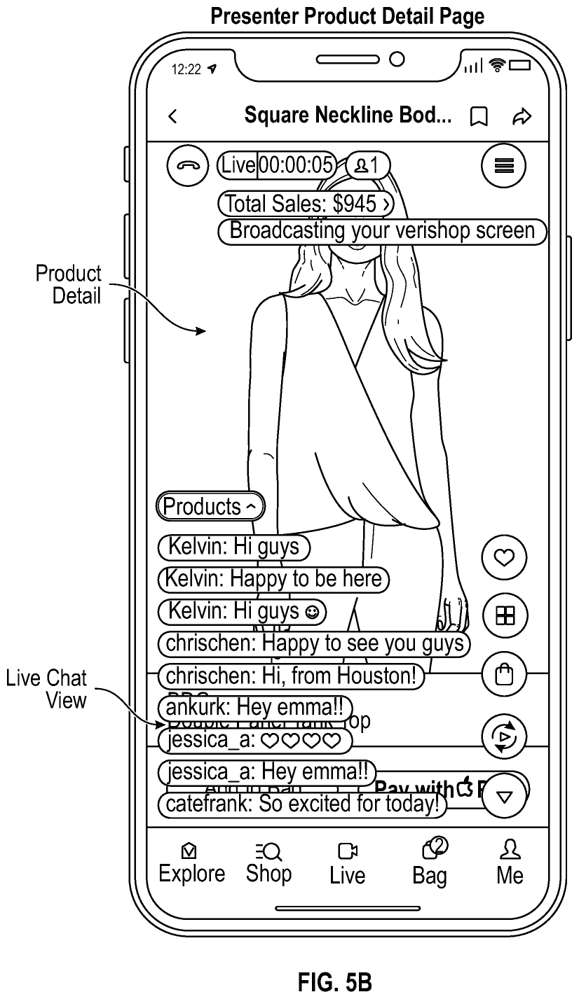

FIG. 5A depicts an example presenter GUI on a display of an electronic device 104 used during a live shopping broadcast. The presenter GUI includes a live shopping broadcast window on a main portion of a display screen for the electronic device. The live shopping broadcast window depicts a live video feed of the presenter captured via a camera of the electronic device. The presenter GUI also includes a product tile carousel including tile for product(s) the presenter preselected prior to the live shopping broadcast. During the live shopping broadcast, the presenter may scroll through the tile carousel by dragging a finger on a screen of the electronic device in the vicinity of the tile carousel and select particular product tiles by tapping on the screen on the electronic device over a displayed a product tile. Selecting a particular product tile prompts the electronic device to send a product identifier to a backend system. The presenter GUI additionally includes a live chat that depicts text typed by viewers of the live shopping broadcast.

FIG. 5B depicts an example presenter product detail page GUI for presentation on a display of a client-side electronic device of the presenter/host. The presenter product detail page depicts product detail (as opposed to the live shopping broadcast window). The presenter product detail page GUI additionally includes the live chat that depicts text typed by viewers of the live shopping broadcast.

In one example, the host can cast their screen (e.g., the presenter product detail page GUI) for display by the viewers' mobile devices. In accordance with this example, the host selects a cast icon on the presenter GUI that is communicated to the back end, which serves the cast screen to the viewers' client devices. This feature is useful if, for example, the presenter wants to talk about products that they don't physically have in hand and haven't added to their collection (which serves as an ad hoc presentation). Additionally, the presenter may use this feature to effectively “pause” their broadcast intermittently, e.g., to change outfits, which is more valuable and interesting to the user than just seeing a blank “video off” screen.

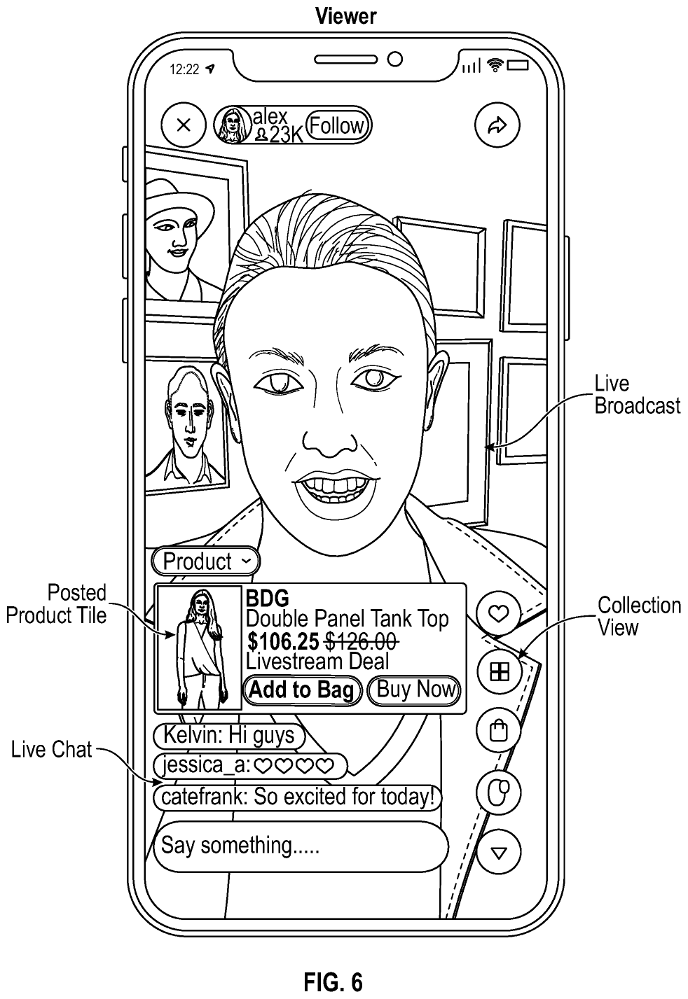

FIG. 6 depicts a viewer GUI on a display of an electronic device 104 used during a live shopping broadcast. The viewer GUI includes a live shopping broadcast window on a main portion of a display screen for the electronic device. The live shopping broadcast window depicts a live video feed of the presenter captured via a camera of the presenter electronic device and forwarded to the viewer electronic device via the backend system. Additionally, audio captured by a microphone of the presenter electronic device is forwarded to the viewer electronic device via the backend system. The presenter GUI additionally includes a live chat that depicts text typed by viewers of the live shopping broadcast.

The viewer GUI also includes a product tile including a tile corresponding to the tile currently selected from the tile carousel by the presenter on the presenter electronic device. In an example, when the presenter selects a tile from the tile carousel on the presenter electronic device, a corresponding product identifier is sent to the back end, which, in turn sends a selectable tile for overlay over a portion of the live shopping broadcast on the display of the viewer electronic device. Selecting the product tile prompts the electronic device to send a product identifier to a backend system, which serves a product detail page (FIG. 7A) for presentation on the display of the electronic device 104 of the viewer.

The viewer GUI also includes a collection view icon that links to a collection view page (FIG. 7D). In an example, when the viewer selects the collection view icon on their electronic device, a collection identifier is sent to the back end, which, in turn serves a collection view page (FIG. 7D) for display on the viewer electronic device.

FIG. 7A depicts a product detail page. The product detail page, when accessed via a live shopping broadcast page (FIG. 6) depicts details about the product in a main display area. When the product detail page is presented in the main display area, the live shopping broadcast is presented as a picture in picture (PIP) overlay on a portion of the main display area. Selection of the live shopping broadcast PIP returns the view to the live shopping broadcast page (FIG. 6). The product detail page includes purchase links and shopping cart links.

FIG. 7B is an example live broadcast focus presenter GUI presented on a display of a client-side electronic device. The broadcast focus GUI includes the full live shopping broadcast that is accessible after the live shopping broadcast. A product tile corresponding to the product currently being discussed in a playback of the broadcast is overlaid on a portion of the broadcast. Additionally, product details for all products associated with the live shopping product are set forth below the live shopping broadcast. A product detail page (FIG. 7A) is accessed for a particular product by selecting the product PIP or the product detail.

FIG. 7C is an example product focus presenter GUI presented on a display of a client-side electronic device. The product focus presenter GUI depicts product details for products selected by a presenter of inclusion on their product focus presenter page. Product broadcast links for recorded portions of live shopping broadcast corresponding to specific products are associated (e.g., overlaid) on product details for those products.

FIG. 7D is an example collection view GUI displaying all products selected by the host for presentation. In one example, the viewer has the ability to preview the full collection that the host compiled before, during, or after the event. In other words, the viewer doesn't have to wait for the host to present the product to view and shop any of the products the host has selected for presentation. The viewer may access a collection view such as depicted in FIG. 7D by selecting a collection view icon (see FIG. 6) of a GUI presented on their device. Selection of the icon prompts the server to serve the entire collection being presented on by the host for display on the collection view GUI. The viewer may then interact with the products on the collection view GUI. For example, the viewer may select a heart icon adjacent a product to indicate they like that product (for later viewing and purchase consideration) or a bag icon adjacent a product to add that product to a shopping cart for purchase. The viewer can return to the live broadcast by selecting an exit icon (e.g., an “x” in the upper right corner of the GUI). Viewer selections are communicated by the client device to the server system.

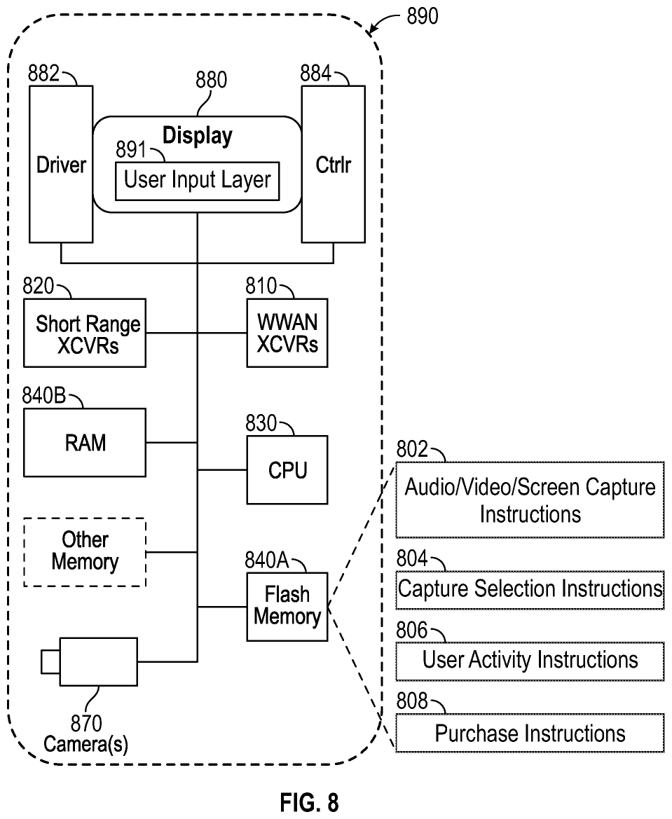

FIG. 8 is a high-level functional block diagram of an example electronic devices 104 embodied as an example mobile device 890 that includes the client system 300. Mobile device 890 includes a flash memory 840A which includes programming to perform all or a subset of the functions described herein for the client system 300. Programming includes, by way of non-limiting example, audio/video/screen capture instructions 802 for capturing information at the electronic device 104, capture selection instructions 804 for selecting captured information to send to the backend system 102 (e.g., camera capture frames or display frames), user activity instructions 806 for determining what the user is currently doing (e.g., based on information in a presentation layer, input selections by the user, or a combination thereof), and purchase instructions 808 to enable secure checkout of items in a user's cart. Mobile device 890 can include a camera 870 that comprises a visible light camera. Memory 840A may further include multiple images or video, which are generated via the camera 870.

As shown, the mobile device 890 includes an image display 880, an image display driver 882 to control the image display 880, and a controller 884. In the example of FIG. 8, the image display 880 and a user input device are integrated together into a touch screen display.

Examples of touch screen type mobile devices that may be used include (but are not limited to) a smart phone, a personal digital assistant (PDA), a tablet computer, a laptop computer, or other portable device. However, the structure and operation of the touch screen type devices is provided by way of example; and the subject technology as described herein is not intended to be limited thereto. For purposes of this discussion, FIG. 8 therefore provides block diagram illustrations of the example mobile device 890 having a touch screen display for displaying content and receiving user input as (or as part of) the user interface.

As shown in FIG. 8, the mobile device 890 includes at least one digital transceiver (XCVR) 810, shown as WWAN XCVRs, for digital wireless communications via a wide area wireless mobile communication network. The mobile device 890 also includes additional digital or analog transceivers, such as short range XCVRs 820 for short-range network communication, such as via NFC, VLC, DECT, ZigBee, Bluetooth™, or WiFi. For example, short range XCVRs 820 may take the form of any available two-way wireless local area network (WLAN) transceiver of a type that is compatible with one or more standard protocols of communication implemented in wireless local area networks, such as one of the Wi-Fi standards under IEEE 802.11.

The transceivers 810, 820 (network communication interface) conforms to one or more of the various digital wireless communication standards utilized by modern mobile networks. Examples of WWAN transceivers 810 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” For example, the transceivers 810, 820 provide two-way wireless communication of information including digitized audio signals, still image and video signals, web page information for display as well as web related inputs, and various types of mobile message communications to/from the mobile device 890.

The mobile device 890 further includes a microprocessor, shown as CPU 830, sometimes referred to herein as the host controller. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 830, for example, may be based on any known or available microprocessor architecture, such as a Reduced Instruction Set Computing (RISC) using an ARM architecture, as commonly used today in mobile devices and other portable electronic devices. Of course, other processor circuitry may be used to form the CPU 830 or processor hardware in smartphone, laptop computer, and tablet.

The microprocessor 830 serves as a programmable host controller for the mobile device 890 by configuring the mobile device 890 to perform various operations, for example, in accordance with instructions or programming executable by processor 830. For example, such operations may include various general operations of the mobile device, as well as operations related to implementing a live shopping experience. Although a processor may be configured by use of hardwired logic, typical processors in mobile devices are general processing circuits configured by execution of programming.

The mobile device 890 includes a memory or storage device system, for storing data and programming. In the example, the memory system may include a flash memory 840A and a random access memory (RAM) 840B. The RAM 840B serves as short term storage for instructions and data being handled by the processor 830, e.g., as a working data processing memory. The flash memory 840A typically provides longer term storage.

Hence, in the example of mobile device 890, the flash memory 840A is used to store programming or instructions for execution by the processor 830. Depending on the type of device, the mobile device 890 stores and runs a mobile operating system through which specific applications are executed. Applications may be a native application, a hybrid application, or a web application (e.g., a dynamic web page executed by a web browser) that runs on mobile device 890. Examples of mobile operating systems include Google Android, Apple iOS (I-Phone or iPad devices), Windows Mobile, Amazon Fire OS, RIM BlackBerry operating system, or the like.

FIG. 9 is a diagrammatic representation of a machine 900 within which instructions 908 (e.g., software, a program, an application, an applet, an app, or other executable code) for causing the machine 900 to perform any one or more of the methodologies discussed herein may be executed. For example, the instructions 908 may cause the machine 900 to execute any one or more of the methods described herein. The instructions 908 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment.

The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines that individually or jointly execute the instructions 908 to perform any one or more of the methodologies discussed herein.

The machine 900 may include processors 902, memory 904, and I/O components 942, which may be configured to communicate with each other via a bus 944. In an example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 includes a main memory 912, a static memory 914, and a storage unit 916, all accessible to the processors 902 via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 (e.g., a non-transitory machine-readable storage medium) within the storage unit 916, within at least one of the processors 902 (e.g., within the processor's cache memory), or any suitable combination thereof, during execution thereof by the machine 900.

Furthermore, the machine-readable medium 918 is non-transitory (in other words, not having any transitory signals) in that it does not embody a propagating signal. However, labeling the machine-readable medium 918 “non-transitory” should not be construed to mean that the medium is incapable of movement; the medium should be considered as being transportable from one physical location to another. Additionally, since the machine-readable medium 918 is tangible, the medium may be a machine-readable device.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones may include a touch input device or other such input mechanisms, while a headless server machine will likely not include such a touch input device. It will be appreciated that the I/O components 942 may include many other components that are not shown in FIG. 9. In various examples, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

Communication may be implemented using a wide variety of technologies. The I/O components 942 further include communication components 940 operable to couple the machine 900 to a network 920 or devices 922 via a coupling 924 and a coupling 926, respectively. For example, the communication components 940 may include a network interface component or another suitable device to interface with the network 920. In further examples, the communication components 940 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 922 may be another machine or any of a wide variety of peripheral devices (e.g., a peripheral device coupled via a USB).

The various memories (e.g., memory 904, main memory 912, static memory 914, memory of the processors 902), storage unit 916 may store one or more sets of instructions and data structures (e.g., software) embodying or used by any one or more of the methodologies or functions described herein. These instructions (e.g., the instructions 908), when executed by processors 902, cause various operations to implement the disclosed examples.

The instructions 908 may be transmitted or received over the network 920, using a transmission medium, via a network interface device (e.g., a network interface component included in the communication components 940) and using any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922.

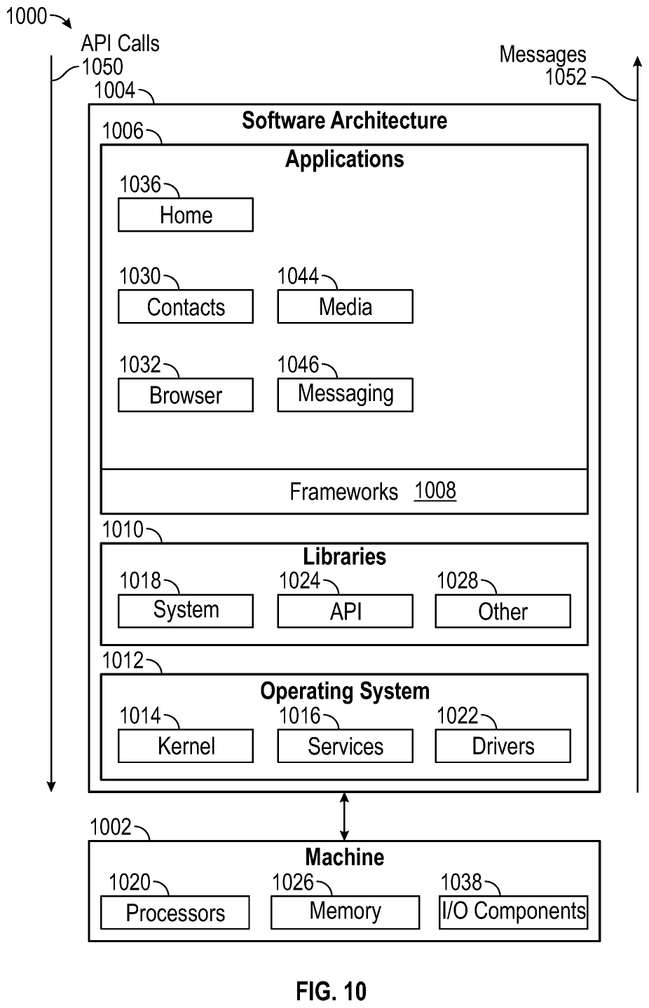

FIG. 10 is a block diagram 1000 illustrating a software architecture 1004, which can be installed on any one or more of the devices described herein. The software architecture 1004 is supported by hardware such as a machine 1002 that includes processors 1020, memory 1026, and I/O components 1038. In this example, the software architecture 1004 can be conceptualized as a stack of layers, where each layer provides a particular functionality. The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1010 provide a low-level common infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1028 to provide many other APIs to the applications 1006.

The frameworks 1008 provide a high-level common infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform.

In an example, the applications 1006 may include a home application 1036, a contacts application 1030, a browser application 1032, a media application 1044, and a messaging application 1046. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the third-party application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, a third-party application can invoke the API calls 1050 provided by the operating system 1012 to facilitate functionality described herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g., approximate, substantially, or about), may vary by as much as ±10% from the recited amount.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A system for implementing live shopping, the system comprising:
a broadcast module configured to receive a broadcast stream from a presenter for a live shopping broadcast, distribute the broadcast stream to viewers, receive a first start identifier for a first product from the presenter during the broadcast stream, distribute product details for the first product to the viewers upon receipt of the first start identifier for the product, receive a first end identifier for the first product from the presenter during the broadcast stream, receive a second start identifier for a second product from the presenter during the broadcast stream, distribute product details for the second product to the viewers upon receipt of the second start identifier for the second product, and receive a second end identifier for the second product from the presenter during the broadcast stream; and
a recording module configured to record the broadcast stream, associate a first portion of the broadcast stream for the live shopping broadcast including a first discussion from the live shopping broadcast of the first product by the presenter with the first product corresponding to a first time period between the first start identifier and the first end identifier of the broadcast stream for the live shopping broadcast, associate a second portion of the broadcast stream for the live shopping broadcast including a second discussion from the live shopping broadcast of the second product by the presenter with the second product corresponding to a second time period between the second start identifier and the second end identifier of the broadcast stream for the live shopping broadcast, generate a first product broadcast file including the first portion of the broadcast stream, including the first discussion from the live shopping broadcast of the first product by the presenter, and a first product identifier for the first product, generate a second product broadcast file including the second portion of the broadcast stream, including the second discussion from the live shopping broadcast of the second product by the presenter, and a second product identifier for the second product, and store the first and second product broadcast files.

2. The system of claim 1, wherein the broadcast module is further configured to receive a subsequent start identifier for the first product from the presenter during the broadcast stream after distribution of product details for the second product and a subsequent end identifier for the first product during the broadcast stream.

3. The system of claim 2, wherein the recording module is further configured to associate with the first product a subsequent portion of the broadcast stream corresponding to a time period between the subsequent start identifier and the subsequent end identifier, generate a subsequent product broadcast file including the first portion and the subsequent portion of the broadcast stream and the first product identifier, and store the subsequent product broadcast file.

4. The system of claim 3, wherein the subsequent start identifier for the first product is the second end identifier for the second product.

5. The system of claim 3, the system further comprising:
a shopping module configured to display a page including the first product, a link to the subsequent product broadcast file, and purchasing information for the first product.

6. The system of claim 3, the system further comprising:
a presenter module configured to serve a page including information about the presenter, the first product, and a link to the subsequent product broadcast file associated with the first product.

7. The system of claim 1, wherein, prior to the live shopping broadcast, the broadcast module is further configured to receive broadcast details from the presenter, present products in an online market to the presenter for selection, receive product selections including at least the first product, and associate the product selections with the live shopping broadcast.

8. The system of claim 7, wherein the broadcast module is further configured to present the product selections to the presenter for selection during the live shopping broadcast and selection of the first product is the first start identifier.

9. The system of claim 7, wherein the broadcast module presents the product selections in a carousel for selection during the live shopping broadcast.

10. The system of claim 7, the system further comprising:
an invitation module coupled to the broadcast module, wherein the invitation module sends an announcement of the broadcast to potential viewers responsive to the broadcast details.

11. The system of claim 1, the system further comprising:
a checkout module coupled to the broadcast module, wherein the checkout module tracks purchases associated with the products presented during the live shopping broadcast and credits the presenter for each of the associated purchases.

12. A method for implementing live shopping, the method comprising:
receiving a broadcast stream from a presenter for a live shopping broadcast;
recording the broadcast stream;
distributing the broadcast stream to viewers;
receiving a first start identifier for a product from the presenter during the broadcast stream;
distributing product details for the first product to the viewers upon receipt of the first start identifier for the first product;
receiving a first end identifier for the first product from the presenter during the broadcast stream;
receiving a second start identifier for a product from the presenter during the broadcast stream;
distributing product details for the second product to the viewers upon receipt of the second start identifier for the second product;
receiving an end identifier for the second product from the presenter during the broadcast stream;
associating a first portion of the broadcast stream for the live shopping broadcast including a first discussion from the live shopping broadcast of the first product by the presenter with the first product corresponding to a first time period between the first start identifier and the first end identifier of the broadcast stream for the live shopping broadcast and a second portion of the broadcast stream for the live shopping broadcast including a second discussion from the live shopping broadcast of the second product by the presenter with the second product corresponding to a second time period between the second start identifier and the second end identifier of the broadcast stream for the live shopping broadcast,
generating a first product broadcast file including the first portion of the broadcast stream, including the first discussion from the live shopping broadcast of the first product by the presenter, and a first product identifier for the first product and a second product broadcast file including the second portion of the broadcast stream, including the second discussion from the live shopping broadcast of the second product by the presenter, and a second product identifier for the second product; and
storing the first product broadcast file and the second product broadcast file.

13. The method of claim 12, further comprising:
receiving a subsequent start identifier for the first product from the presenter during the broadcast stream after distribution of product details for the second product and a subsequent end identifier for the first product during the broadcast stream.

14. The method of claim 13, further comprising:
associating with the first product a subsequent portion of the broadcast stream corresponding to a time period between the subsequent start identifier and the subsequent end identifier;
generating a subsequent product broadcast file including the first portion and the subsequent portion of the broadcast stream and the first product identifier; and
storing the subsequent product broadcast file.

15. The method of claim 14, the method further comprising:
serving a page including the first product, a link to the subsequent product broadcast file, and purchasing information for the first product.

16. The method of claim 14, the method further comprising:
serving a page including information about the presenter, the first product, and a link to the subsequent product broadcast file associated with the first product.

17. The method of claim 12, the method further comprising:
receiving a collection view selection from a client device of a viewer; and
serving a collection view page to the client device of the viewer that simultaneously depicts the first product and the second product responsive to the collection view selection.

18. The method of claim 12, the method further comprising:
receiving a screen cast selection from a client device of the presenter;
serving the screen of the presenter to client devices of the viewers responsive to the screen cast selection.

19. The method of claim 12, further comprising, prior to the live shopping broadcast:
receiving broadcast details from the presenter;
presenting products in an online market to the presenter for selection;
receiving product selections including at least the first product; and
associating the product selections with the live shopping broadcast.

20. The method of claim 19, further comprising:
presenting the product selections to the presenter for selection during the live shopping broadcast and selection of the first product is the first start identifier.

21. The method of claim 12, the method further comprising:
tracking purchases associated with the products presented during the live shopping broadcast; and
crediting the presenter for each of the associated purchases.

22. A non-transitory computer readable medium including instructions for implementing live shopping, the instructions, when executed by a processor configure a live shopping system to:
receive a broadcast stream from a presenter for a live shopping broadcast;
record the broadcast stream;
distribute the broadcast stream to viewers;
receive a first start identifier for a first product from the presenter during the broadcast stream;
distribute product details for the first product to the viewers upon receipt of the first start identifier for the first product;
receive a first end identifier for the first product from the presenter during the broadcast stream;
receive a second start identifier for a second product from the presenter during the broadcast stream;
distribute product details for the second product to the viewers upon receipt of the second start identifier for the second product;
receive a second end identifier for the second product from the presenter during the broadcast stream;
associate a first portion of the broadcast stream for the live shopping broadcast including a first discussion from the live shopping broadcast of the first product by the presenter with the first product corresponding to a first time period between the first start identifier and the first end identifier of the broadcast stream for the live shopping broadcast and a second portion of the broadcast stream for the live shopping broadcast including a second discussion from the live shopping broadcast of the second product by the presenter with the second product corresponding to a second time period between the second start identifier and the second end identifier of the broadcast stream for the live shopping broadcast;
generate a first product broadcast file including the first portion of the broadcast stream, including the first discussion from the live shopping broadcast of the first product by the presenter, and a first product identifier for the first product and a second product broadcast file including the second portion of the broadcast stream, including the second discussion from the live shopping broadcast of the second product by the presenter, and a second product identifier for the second product; and
store the first product broadcast file and the second product broadcast file.
